(19) United States
(12) Patent Application Publication
(10) Pub. No.: US 2023/0253602 A1
(43) Pub. Date: Aug. 10, 2023

(54) FUEL CELL SYSTEM AND FUEL SUPPLY METHOD THEREOF

(71) Applicant: HYUNDAI MOBIS Co., Ltd., Seoul (KR)

(72) Inventor: Yong Hee LEE, Yongin-si (KR)

(73) Assignee: HYUNDAI MOBIS Co., Ltd., Seoul (KR)

(21) Appl. No.: 18/085,059

(22) Filed: Dec. 20, 2022

(30) Foreign Application Priority Data
Feb. 8, 2022 (KR) 10-2022-0016280

(51) Int. Cl. H01M 8/22; H01M 8/04302

(52) U.S. Cl. CPC H01M 8/22; H01M 8/04302

(57) ABSTRACT

A fuel cell system includes a first valve installed at an outlet of a hydrogen tank on a fuel supply line connecting the hydrogen tank and a fuel cell stack, a second valve installed at a rear end of the first valve on the fuel supply line, and a fuel cell control unit that controls operations of the first valve and the second valve based on a state of the hydrogen tank when a startup of a fuel cell is required.

### CROSS-REFERENCE TO RELATED APPLICATION

This application claims the benefit of priority to Korean Patent Application No. 10-2022-0016280, filed in the Korean Intellectual Property Office on Feb. 8, 2022, the entire contents of which are incorporated herein by reference.

### TECHNICAL FIELD

The present disclosure relates to a fuel cell system, and a fuel supply method thereof.

### BACKGROUND

In recent years, fuel cells are utilized as power sources of moving bodies, such as vehicles or construction machines. A fuel cell converts chemical energy generated through a reaction of a hydrogen fuel and oxygen in a fuel cell stack into electrical energy, and drives a motor by using the electrical energy then to generate a propulsion force of the moving body.

Because the moving body employing the fuel cell uses hydrogen as the fuel, it employs a hydrogen tank that stores a specific amount of hydrogen. Because the hydrogen tank is a part, to which an attention is made for safety, a notification is made by a controller of the fuel cell system when a state of the hydrogen tank does not satisfy an operation condition while the state is always monitored. Accordingly, when a notification is generated according to the state of the hydrogen tank, a fuel cell system that desires to prevent a dangerous accident may interrupt a startup.

The fuel cell system counts a pause time of a power pack and, when the pause time exceeds a specific time, outputs a sleep command to a controller, such as an actuator. In this case, the controller that monitors the state of the hydrogen tank also is converted to a sleep state, and a vehicle may not be started as a pressure and a temperature of the hydrogen tank is not measured when a startup is requested.

A vehicle employing a fuel cell usually does not pause for a long time, but because a non-vehicle (a construction machine or the like) employing a fuel cell frequently pauses for a long time, a frequent startup problem of a fuel cell system may make users unsatisfactory.

### SUMMARY

The present disclosure has been made to solve the above-mentioned problems occurring in the prior art while advantages achieved by the prior art are maintained intact.

An aspect of the present disclosure provides a fuel cell system that detects a pressure of a hydrogen tank through a high-pressure sensor while the pressure is adjusted by opening a preconditioning valve to satisfy a startup condition of the fuel cell system when the pressure is not identified during a startup of the fuel cell system and the hydrogen tank is in a startup disable state, and a fuel supply method thereof.

Another aspect of the present disclosure provides a fuel cell system that solves a startup problem that is generated as a pressure is not identified during a startup in a sleep state of a controller of the fuel cell system to enhance a satisfaction of a consumer, and a fuel supply method thereof.

The technical problems to be solved by the present disclosure are not limited to the aforementioned problems, and any other technical problems not mentioned herein will be clearly understood from the following description by those skilled in the art to which the present disclosure pertains.

A fuel cell system according to an aspect of the present disclosure includes a first valve installed at an outlet of a hydrogen tank on a fuel supply line connecting the hydrogen tank and a fuel cell stack, a second valve installed at a rear end of the first valve on the fuel supply line, and a fuel cell control unit that controls operations of the first valve and the second valve based on a state of the hydrogen tank when a startup of a fuel cell is required.

In an embodiment, the first valve may be a preconditioning valve, and the second valve may be a valve for adjusting a flow rate of hydrogen supplied from the hydrogen tank.

In an embodiment, the fuel cell system may further include a hydrogen manufacturing unit that identifies a state of the hydrogen tank when the start of the fuel cell is requested.

In an embodiment, the hydrogen manufacturing unit may be configured to identify whether pressure and temperature of the hydrogen tank are normal, and identify whether a state notification function for the states of the hydrogen tank is normally operated. The hydrogen manufacturing unit may be configured to determine that the state of the hydrogen tank is in a normal state when the pressure and temperature of the hydrogen tank are identified as normal.

In an embodiment, the fuel cell control unit may be configured to determine that the first valve is opened when the state of the hydrogen tank is not identified, and determine that the second valve is opened when it is identified that the hydrogen tank is in the normal state.

In an embodiment, the fuel cell control unit may be configured to notify a fuel cell startup disable state when it is identified that the state notification function for the hydrogen tank is not normally operated.

In an embodiment, the fuel cell control unit may be configured to control the startup of the fuel cell when it is identified that the state notification function for the hydrogen tank is normally operated and the pressure and temperature of the hydrogen tank are identified as normal.

In an embodiment, the fuel cell control unit may be configured to determine a fuel cell startup disable state when it is identified that the state notification function for the hydrogen tank is normally operated and the pressure and temperature of the hydrogen tank are not identified as normal.

In an embodiment, the fuel cell control unit may be configured to control such that a state, in which the second valve is closed, is changed to a state, in which the first valve is opened, in the fuel cell startup disable state.

In an embodiment, the fuel cell system may further include a sensor that measures a pressure of hydrogen discharged through the fuel supply line when the first valve is opened.

In an embodiment, the hydrogen manufacturing unit may be configured to identify the pressure and temperature of the hydrogen tank in real time based on the pressure measured through the sensor when the first valve is opened.

In an embodiment, the fuel cell control unit may be configured to output a signal for controlling opening of the second valve when it is identified that the pressure and temperature of the hydrogen tank are normal, and the hydrogen manufacturing unit may be configured to control such that the second valve is opened according to the signal output from the fuel cell control unit.

In an embodiment, the fuel cell control unit may be configured to notify the fuel cell startup disable state when the pressure and temperature of the hydrogen tank are not identified as normal until a specific time period elapses after the first valve is opened.

A fuel supply method of a fuel cell system according to an aspect of the present disclosure includes identifying a state of a hydrogen tank when a startup of a fuel cell is requested, and controlling operations of a first valve installed at an outlet of the hydrogen tank on a fuel supply line connecting the hydrogen tank and the fuel cell stack and a second valve installed at a rear end of the first valve on the fuel supply line, based on a state of the hydrogen tank.

In an embodiment, the identifying of the state may include identifying whether pressure and temperature of the hydrogen tank are normal, and identifying whether a state notification function for the states of the hydrogen tank is normally operated.

In an embodiment, the fuel supply method may further include notifying a fuel cell startup disable state when it is identified that the state notification function for the hydrogen tank is not normally operated.

In an embodiment, the fuel supply method may further include controlling the startup of the fuel cell when it is identified that the state notification function for the hydrogen tank is normally operated and the pressure and temperature of the hydrogen tank are identified as normal.

In an embodiment, the fuel supply method may further include determining a fuel cell startup disable state when it is identified that the state notification function for the hydrogen tank is normally operated and the pressure and temperature of the hydrogen tank are not identified as normal.

In an embodiment, the controlling may include opening the first valve in a state, in which the second valve is closed, in the fuel cell startup disable state.

In an embodiment, the fuel supply method may further include measuring a pressure of the hydrogen discharged through the fuel supply line when the first valve is opened, and identifying the pressure and temperature of the hydrogen tank again based on the measured pressure.

In an embodiment, the controlling may include opening the second valve when it is identified that the pressure and temperature of the hydrogen tank are identified as normal.

In an embodiment, the fuel supply method may further include notifying the fuel cell startup disable state when it is identified that the pressure and temperature of the hydrogen tank are not identified as normal until a specific time period elapses after the first valve is opened.

### BRIEF DESCRIPTION OF THE DRAWINGS

The above and other objects, features and advantages of the present disclosure will be more apparent from the following detailed description taken in conjunction with the accompanying drawings:

FIG. 1 is a view illustrating a configuration of a fuel cell system according to an embodiment of the present disclosure;

FIG. 2 is a view illustrating an embodiment that is referred in describing an operation of controlling a valve according to a state of a hydrogen tank of a fuel cell system according to an embodiment of the present disclosure; and

FIG. 3 is a view illustrating operation flows of a fuel supply method of a fuel cell system according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present disclosure relates to a fuel cell system, and the fuel cell system according to the present disclosure may be applied to a moving body employing a fuel cell. Here, the moving body may include a vehicle employing a fuel cell, and may include a non-vehicle, such as an excavation machine, a loading machine, or a machine for concrete, which employs a fuel cell.

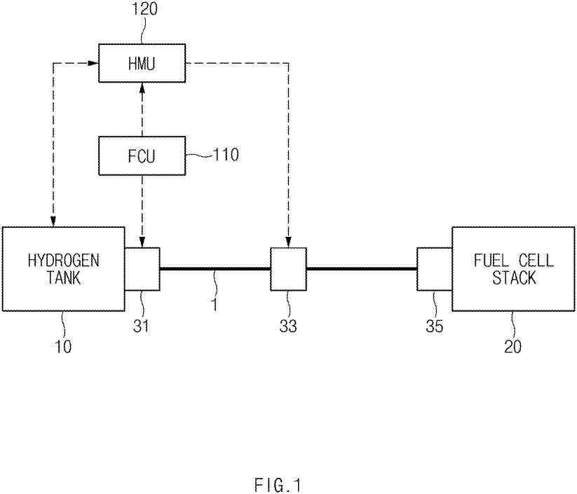

FIG. 1 is a view illustrating a configuration of a fuel cell system according to an embodiment of the present disclosure.

Referring to FIG. 1, the fuel cell system includes a hydrogen tank 10 and a fuel cell stack 20, and may include a first valve 31, a second valve 33, and a third valve 35 installed on a fuel supply line 1 that connects the hydrogen tank 10 and the fuel cell stack 20. Furthermore, the fuel cell system may further include a hydrogen manufacturing unit (HMU)120 that monitors a state of the hydrogen tank 10 and controls operations of components connected to the hydrogen tank 10 according to a state of hydrogen.

The hydrogen tank 10 is a hydrogen storage that stores a fuel that is supplied to the fuel cell stack 20, that is, hydrogen, and a sensor for monitoring a pressure, a temperature, and the like of hydrogen may be installed in an interior thereof.

The fuel supply line 1 connected to the fuel cell stack 20 is installed at an outlet of the hydrogen tank 10, which supplies the stored hydrogen, and the hydrogen is supplied to the fuel cell stack 20 through the fuel supply line 1.

The fuel cell stack 20 may have a structure that may produce electricity through an oxidation/reduction reaction of the hydrogen supplied from the hydrogen tank 10 through the fuel supply line 1, and air.

As an example, the fuel cell stack 20 may include a membrane electrode assembly (MEA), in which catalyst electrode layers for an electric chemical reaction are attached to opposite sides of a membrane with respect to an electrolyte membrane, through which hydrogen ions travel, a gas diffusion layer (GDL) that uniformly distributes reaction gases and delivered generated electrical energy, a gasket and a coupling mechanism for maintaining a tightness and a proper coupling pressure of the reaction gases and the first cooling water, and a bipolar plate that causes the reaction gases and the first cooling water to flow.

In the fuel cell stack 20, the hydrogen that is the fuel and the air (oxygen) that is the oxidizer are supplied to an anode and a cathode of the membrane electrode assembly, and the hydrogen may be supplied to the anode and the air may be supplied to the cathode. The hydrogen supplied to the anode is decomposed into protons and electrons by a catalyst of the electrode layers provided on opposite sides of the electrolyte membrane, and among them, only the hydrogen ions may be delivered to the cathode after selectively passing the electrolyte membrane that is a cation exchange membrane, and the electrons may be delivered to the cathode through the gas diffusion layer and the bipolar plate. In the cathode, the hydrogen ions supplied through the electrolyte membrane and the electrons delivered through the bipolar plate may meet oxygen in the air supplied to the cathode by an air supply device and may generate a reaction of generating water. Then, the electrons may flow through an external wire due to the flows of the hydrogen ions, and electric currents may be generated due to the flows of the electrons.

Here, the fuel cell stack 20 may be implemented in a form included in a fuel cell power pack. The fuel cell power pack may mean a package including the fuel cell stack 20, and modules that are necessary for supplying electric power from the fuel cell stack 20.

The first valve 31 is a preconditioning valve, and may be installed at the outlet of the hydrogen tank 10 on the fuel supply line 1. The first valve 31 is a valve that may adjust an opening degree through a continuous control, and a control valve may be determined by a fuel cell control unit (FCU) 110 that is an upper-level controller.

The third valve 35 is a valve that adjusts a flow rate of the hydrogen introduced into the fuel cell stack 20, and may be installed at an inlet of the fuel cell stack 20 on the fuel supply line 1. The third valve 35 may be opened when a pressure of the hydrogen introduced through the fuel supply line 1 is high enough to be used in the fuel cell stack 20. Although not illustrated in FIG. 1, a regulator that adjusts high-pressure hydrogen supplied through the fuel supply line 1 to a pressure that is high enough to be used in the fuel cell stack 20 and the like may be installed at a front end of the third valve 35.

The second valve 33 is a valve that adjusts a flow rate of the hydrogen that is discharged from the hydrogen tank 10 and passes through the fuel supply line 1, and may be installed between the first valve 31 and the third valve 35 on the fuel supply line 1. The second valve 33 may be opened according to the pressure of the hydrogen that passes through the fuel supply line 1. Of course, the second valve 33 may be opened only in a state, in which the hydrogen tank 10 may normally supply hydrogen or supply of hydrogen may be controlled.

As an example, the first valve 31, the second valve 33, and the third valve 35 may be implemented by solenoid valves.

Opening or closing of the first valve 31, the second valve 33, and the third valve 35 may be determined by the fuel cell control unit (FCU) 110 that is an upper level controller of the fuel cell system.

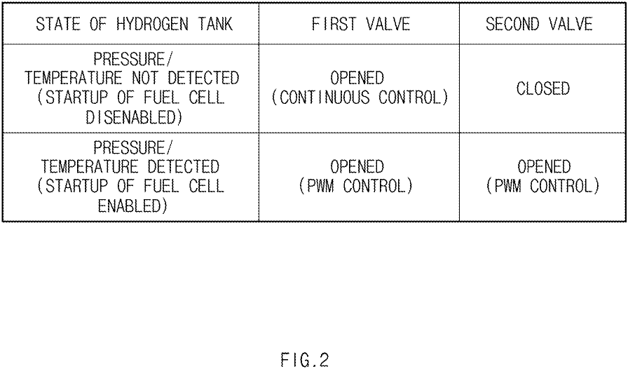

The fuel cell control unit (FCU) 110 may determine opening or closing of the first valve 31 and the second valve 33 according to the state of the hydrogen tank 10 when a startup of a fuel cell is requested. The fuel cell control unit (FCU) 110 may determine opening or closing of the first valve 31 and the second valve 33 based on a table illustrated in FIG. 2.

Furthermore, the fuel cell control unit (FCU) 110 may determine opening or closing of the third valve 35 according to a pressure of the hydrogen at a front end of the third valve 35 when the hydrogen is supplied along the fuel supply line 1.

Then, the fuel cell control unit (FCU) 110 may output a control signal corresponding to opening or closing of the first valve 31 and/or the third valve 35 to the first valve 31 and/or the third valve 35 when the opening or the closing of the first valve 31 and/or the third valve 35 is determined.

Accordingly, the first valve 31 and/or the third valve 35 may be opened or closed according to the control signal from the fuel cell control unit (FCU) 110.

Meanwhile, when opening or closing of the second valve 33 is determined by the fuel cell control unit (FCU) 110, the opening or the closing may be controlled by the hydrogen manufacturing unit (HMU) 120 according to the determination of the fuel cell control unit (FCU) 110.

Accordingly, when the opening or the closing of the second valve 33 is determined, the fuel cell control unit (FCU) 110 may output a signal for controlling the opening or the closing to the hydrogen manufacturing unit (HMU) 120. Accordingly, the hydrogen manufacturing unit (HMU) 120 may output a control signal corresponding to the opening or the closing to the second valve 33 based on the signal received from the fuel cell control unit (FCU) 110.

The fuel cell control unit (FCU) 110 and the hydrogen manufacturing unit (HMU) 120 may be a hardware device, such as a processor or a central processing unit (CPU), or a program implemented by a processor. The hydrogen manufacturing unit (HMU) 120 may control an overall function according to supply of the hydrogen.

As an example, the hydrogen manufacturing unit (HMU) 120 identifies the state of the hydrogen tank 10 in real time, and provides the state notification function according to the state of the hydrogen tank 10. Furthermore, the hydrogen manufacturing unit (HMU) 120 identifies whether the state of the hydrogen tank 10 satisfies a condition for controlling supply of hydrogen, and controls operations for supplying a fuel, that is, hydrogen to the fuel cell stack 20 when the condition is satisfied.

In detail, the hydrogen manufacturing unit (HMU) 120 identifies the state of the hydrogen tank 10 and the state notification function when a request for startup is made by an operator.

As an example, the hydrogen manufacturing unit (HMU) 120 identifies whether the state of the hydrogen tank 10 is normally identified or a notification function according to the state of the hydrogen tank 10 is normally performed. When the moving body is in a pause state for a long time, the function of monitoring and notifying the state of the hydrogen tank 10 may be released, and because this greatly influences the supply of hydrogen, it is an essential process to identify whether the functions are normally operated when a startup is requested to prevent a safety accident.

Then, the hydrogen manufacturing unit (HMU) 120 determines that a startup of the fuel cell system is impossible and delivers the corresponding information to the fuel cell control unit (FCU) 110 when the state notification function for the state of the hydrogen tank 10 is not normally performed.

Accordingly, the fuel cell control unit (FCU) 110 may recognize a startup disable state of the fuel cell system based on the information received from the hydrogen manufacturing unit (HMU) 120, and may notify the startup disable state of the fuel cell system to a driver.

Meanwhile, the hydrogen manufacturing unit (HMU) 120 identifies states, such as the pressure and the temperature, of the hydrogen tank 10 when the state notification function for the state of the hydrogen tank 10 is normally performed.

When the states, such as the pressure and the temperature, of the hydrogen tank 10 is identified as normal, it determines that the startup of the fuel cell system is possible, and delivers the corresponding information to the fuel cell control unit (FCU) 110. Here, the normal states of the pressure and the temperature of the hydrogen tank 10 means pressure and temperature states that satisfy a hydrogen supply condition. When the pressure and the temperature of the hydrogen tank 10 do not satisfy the hydrogen supply condition or the pressure and the temperature are not identified, the states are determined to be abnormal.

The hydrogen manufacturing unit (HMU) 120 may control supply of hydrogen by estimating a cohesion (concentration) and a residual amount of hydrogen of the hydrogen tank 10 based on this when the pressure and the temperature and the like of the hydrogen tank 10 are identified. Accordingly, the fuel cell control unit (FCU) 110 may recognize a startup enable state of the fuel cell state based on the information received from the hydrogen manufacturing unit (HMU) 120, and may control the startup of the fuel cell system.

The hydrogen manufacturing unit (HMU) 120 cannot estimate a cohesion (concentration) and a residual amount of hydrogen of the hydrogen tank 10 when the pressure and the temperature of the hydrogen tank 10 are not identified in a state, in which the state notification function for the state of the hydrogen tank 10 is normally performed. Accordingly, the hydrogen manufacturing unit (HMU) 120 determines that the startup of the fuel cell system is impossible and delivers the corresponding information to the fuel cell control unit (FCU) 110.

Accordingly, the fuel cell control unit (FCU) 110 recognizes the startup disable state of the fuel cell system based on the information received from the hydrogen manufacturing unit (HMU) 120.

Because the function of detecting the state of the hydrogen tank 10 and/or the state notification function is released when a request of a startup is made after the moving body is in a pause state for a long time, the pressure and the temperature may not be normally identified even when the sensor or the controllers are not abnormal.

Accordingly, when the pressure and the temperature of the hydrogen tank 10 are not identified in a state, in which the state notification function is normally performed, the fuel cell control unit (FCU) 110, as illustrated in the table of FIG. 2, determines that the first valve 31 has to be opened first before the startup disable state of the fuel cell system is notified to the driver. Then, the fuel cell control unit (FCU) 110 determines that the second valve 33 has to be closed until the pressure and the temperature of the hydrogen tank 10 are identified.

Of course, even when the pressure and the temperature of the hydrogen tank 10 are identified in a state, in which the state notification function is normally performed, it may be determined that the first valve 31 is opened first while the second valve 33 is not opened directly even when the pressure and the temperature of the hydrogen tank 10 does not satisfy the hydrogen supply condition.

Accordingly, the fuel cell control unit (FCU) 110 identifies a closing state of the second valve 33 from the hydrogen manufacturing unit (HMU) 120, and outputs a signal for opening the first valve 31 to the first valve 31 when the closing state of the second valve 33 is identified.

The first valve 31 is opened based on the signal from the fuel cell control unit (FCU) 110. Then, the first valve 31 may be continuously controlled according to the control value received from the fuel cell control unit (FCU) 110.

Accordingly, as the first valve 31 is opened by the fuel cell control unit (FCU) 110 in a state, in which the second valve 33 is closed, the hydrogen stored in the hydrogen tank 10 is discharged through the outlet, and the hydrogen discharged from the hydrogen tank 10 is supplied to a front end of the second valve 33 along the fuel supply line 1.

While the hydrogen stored in the hydrogen tank 10 is discharged along the fuel supply line 1, the sensor provided in the hydrogen tank 10 may detect the pressure and the temperature of the hydrogen. As an example, a high-pressure sensor may be installed at a hydrogen outlet of the hydrogen tank 10 and may detect the pressure of the hydrogen discharged from the hydrogen tank 10. The high-pressure sensor may be installed together at a location of the first valve 31.

While the hydrogen stored in the hydrogen tank 10 is discharged along the fuel supply line 1, the hydrogen manufacturing unit (HMU) 120 identifies the state of the hydrogen tank 10 in real time. Then, when normally identifying the pressure and the temperature of the hydrogen tank 10, the hydrogen manufacturing unit (HMU) 120 transmits the corresponding information to the fuel cell control unit (FCU) 110 that is an upper-level controller.

Accordingly, the fuel cell control unit (FCU) 110 identifies state information of the hydrogen tank 10, and as illustrated in the table of FIG. 2, determines that the second valve 33 is opened and transmits a corresponding signal to the hydrogen manufacturing unit (HMU) 120. Accordingly, the hydrogen manufacturing unit (HMU) 120 may output a control signal for opening the second valve 33 to the second valve 33 based on the signal received from the fuel cell control unit (FCU) 110.

The second valve 33 is opened based on the signal from the fuel cell control unit (FCU) 110. Then, the second valve 33 may be PWM-controlled based on the control signal received from the hydrogen manufacturing unit (HMU) 120.

Then, the fuel cell control unit (FCU) 110 may convert the first valve 31 to a PWM control under a continuous control. Then, the first valve 31 may be PWM-controlled by the fuel cell control unit (FCU) 110.

Meanwhile, the hydrogen manufacturing unit (HMU) 120 continuously identifies the pressure and the temperature of the hydrogen tank 10 when the first valve 31 is opened by the fuel cell control unit (FCU) 110.

When the pressure and the temperature of the hydrogen tank 10 are not normally identified in spite that the first valve 31 is opened, the hydrogen manufacturing unit (HMU) 120 determines that a startup of the fuel cell system is impossible and delivers the corresponding information to the fuel cell control unit (FCU) 110. Here, the hydrogen manufacturing unit (HMU) 120 may determine that a startup of the fuel cell system is impossible when the pressure and the temperature of the hydrogen tank 10 are not identified or the pressure and the temperature of the hydrogen tank 10 do not satisfy the hydrogen supply control condition.

Accordingly, the fuel cell control unit (FCU) 110 may recognize a startup disable state of the fuel cell system based on the information received from the hydrogen manufacturing unit (HMU) 120, and may notify the startup disable state of the fuel cell system to a driver.

An operational flow of the apparatus according to the present disclosure will be described in detail.

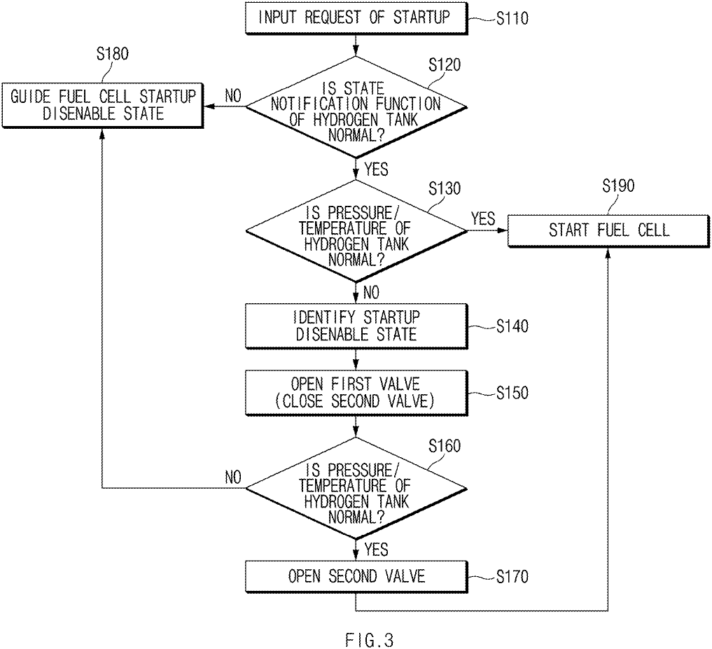

FIG. 3 is a view illustrating operation flows of a fuel supply method of the fuel cell system according to an embodiment of the present disclosure.

Referring to FIG. 3, when a request for a startup is made by the operator (S110), the fuel cell system identifies whether the state of the hydrogen tank 10 and the state notification function are normal. When the state notification function for the state of the hydrogen tank 10 is not normally performed (S120), the fuel cell system may notify the fuel cell startup disable state to the driver (S180).

Meanwhile, when the state notification function for the state of the hydrogen tank 10 is normally performed in process ‘S120’, the fuel cell system identifies whether the states, such as the pressure and the temperature, of the hydrogen tank 10 satisfy the condition for supplying hydrogen to the fuel cell stack 20.

When it is identified that the states, such as the pressure and the temperature, of the hydrogen tank 10 are normal states (S130), the fuel cell system may control supply of hydrogen by estimating a cohesion (concentration) and a residual amount of the hydrogen of the hydrogen tank 10 based on this. Accordingly, when it is identified that the state, such as the pressure and the temperature, of the hydrogen tank 10 are normal states, in process ‘S130’, the fuel cell system may control the startup of the fuel cell. The fuel cell system opens the first valve 31 and the second valve 33 such that the hydrogen is supplied to the fuel cell stack 20 before the startup of the fuel cell is controlled, in process ‘S190’. It may be determined whether the third valve 35 is to be opened according to the pressure of the supplied hydrogen.

When it is identified that the pressure and the temperature of the hydrogen tank 10 are not normal states in process ‘S130’, the fuel cell system cannot control an amount of the supplied hydrogen because the cohesion (concentration) and the residual amount of the hydrogen in the hydrogen tank 10 cannot be estimated, and thus it is identified that the state is a state, in which a startup is impossible (S140). Here, it may be determined that the state is not a normal state when the states, such as the pressure and the temperature, of the hydrogen tank 10 do not satisfy the condition for controlling supply of the hydrogen or it is impossible to identify the pressure and the temperature.

In this case, even when the fuel cell system is not abnormal, the pressure and the temperature may not be identified due to a pause of the moving body for a long time.

Accordingly, the fuel cell system opens the first valve 31 first in a state, in which the second valve 33 is closed (S150). In process ‘S150’, an opening degree of the first valve 31 may be adjusted through a continuous control.

In this, as the first valve 31 is opened in a state, in which the second valve 33 is closed, the hydrogen stored in the hydrogen tank 10 is discharged through the outlet, and the hydrogen discharged from the hydrogen tank 10 is supplied to the front end of the second valve 33 along the fuel supply line 1. While the hydrogen stored in the hydrogen tank 10 is discharged along the fuel supply line 1, the sensor provided in the hydrogen tank 10 may detect the pressure and the temperature of the hydrogen.

The fuel cell system identifies the state of the hydrogen tank 10 in real time through the sensor provided in the hydrogen tank 10. In this process, the fuel cell system may open both of the first valve 31 and the second valve 33 (S170) when it is identified that the pressure and the temperature of the hydrogen tank 10 are normal states (S160), and may control the startup of the fuel cell. In process ‘S170’, opening degrees of the first valve 31 and the second valve 33 may be adjusted through a PWM control. In this case, the fuel cell system may open the third valve 35 when the pressure of the hydrogen applied to a front end of the third valve 35 along the fuel supply line 1 is a pressure that is high enough to be used in the fuel cell stack 20.

Meanwhile, in process ‘S160’, when it is identified that the first valve 31 is opened and the states, such as the pressure and the temperature, of the hydrogen tank 10 are not normal state until a specific time period elapses, the fuel cell system cannot estimate the cohesion (concentration) and the residual amount of the hydrogen of the hydrogen tank 10 and cannot control an amount of the supplied hydrogen, and thus notify the fuel cell startup disable state to the driver (S180).

According to the present disclosure, a fuel cell system detects a pressure of a hydrogen tank through a high-pressure sensor while the pressure is adjusted by opening a preconditioning valve to satisfy a startup condition of the fuel cell system when the pressure is not identified during a startup of the fuel cell system and the hydrogen tank is in a startup disable state.

In addition, according to the present disclosure, a startup problem that is generated as a pressure is not identified during a startup in a sleep state of a controller of the fuel cell system is solved whereby a satisfaction of a consumer is enhanced.

The above description is a simple exemplification of the technical spirits of the present disclosure, and the present disclosure may be variously corrected and modified by those skilled in the art to which the present disclosure pertains without departing from the essential features of the present disclosure.

Accordingly, the embodiments disclosed in the present disclosure is not provided to limit the technical spirits of the present disclosure but provided to describe the present disclosure, and the scope of the technical spirits of the present disclosure is not limited by the embodiments. Accordingly, the technical scope of the present disclosure should be construed by the attached claims, and all the technical spirits within the equivalent ranges fall within the scope of the present disclosure.

What is claimed is:

1. A fuel cell system comprising:
a first valve installed at an outlet of a hydrogen tank on a fuel supply line connecting the hydrogen tank and a fuel cell stack;
a second valve installed at a rear end of the first valve on the fuel supply line; and
a fuel cell control unit configured to control operations of the first valve and the second valve based on a state of the hydrogen tank when a startup of a fuel cell is required.

2. The fuel cell system of claim 1, wherein the first valve is a preconditioning valve, and
wherein the second valve is a valve for adjusting a flow rate of hydrogen supplied from the hydrogen tank.

3. The fuel cell system of claim 1, further comprising:
a hydrogen manufacturing unit configured to identify the state of the hydrogen tank when the startup of the fuel cell is requested.

4. The fuel cell system of claim 3, wherein the hydrogen manufacturing unit is configured to:
identify whether pressure and temperature of the hydrogen tank are normal, and identify whether a state notification function for the state of the hydrogen tank is normally operated, and
determine that the state of the hydrogen tank is in a normal state when the pressure and temperature of the hydrogen tank are identified as normal.

5. The fuel cell system of claim 4, wherein the fuel cell control unit is configured to:
determine that the first valve is opened when the state of the hydrogen tank is not identified, and determine that the second valve is opened when it is identified that the hydrogen tank is in the normal state.

6. The fuel cell system of claim 5, wherein the fuel cell control unit is configured to:
notify a fuel cell startup disable state when it is identified that the state notification function for the hydrogen tank is not normally operated.

7. The fuel cell system of claim 5, wherein the fuel cell control unit is configured to:
control the startup of the fuel cell when it is identified that the state notification function for the hydrogen tank is normally operated and the pressure and temperature of the hydrogen tank are identified as normal.

8. The fuel cell system of claim 5, wherein the fuel cell control unit is configured to:
determine that the hydrogen tank is in a fuel cell startup disable state when it is identified that the state notification function for the hydrogen tank is normally operated and the pressure and temperature of the hydrogen tank are not identified as normal.

9. The fuel cell system of claim 8, wherein the fuel cell control unit is configured to:
control such that a state, in which the second valve is closed, is changed to a state, in which the first valve is opened, in the fuel cell startup disable state.

10. The fuel cell system of claim 9, further comprising:
a sensor configured to measure a pressure of hydrogen discharged through the fuel supply line when the first valve is opened.

11. The fuel cell system of claim 10, wherein the hydrogen manufacturing unit is configured to:
identify the pressure and temperature of the hydrogen tank in real time based on the pressure measured through the sensor when the first valve is opened.

12. The fuel cell system of claim 11, wherein the fuel cell control unit is configured to:
output a signal for controlling opening of the second valve when the pressure and temperature of the hydrogen tank are identified as normal, and
wherein the hydrogen manufacturing unit is configured to:
control such that the second valve is opened according to the signal output from the fuel cell control unit.

13. The fuel cell system of claim 12, wherein the fuel cell control unit is configured to:
notify the fuel cell startup disable state when the pressure and temperature of the hydrogen tank are not identified as normal until a specific time period elapses after the first valve is opened.

14. A fuel supply method of a fuel cell system, comprising:
identifying a state of a hydrogen tank when a startup of a fuel cell is requested; and
controlling operations of a first valve installed at an outlet of the hydrogen tank on a fuel supply line connecting the hydrogen tank and a fuel cell stack and a second valve installed at a rear end of the first valve on the fuel supply line, based on the state of the hydrogen tank.

15. The fuel supply method of claim 14, wherein the identifying of the state of the hydrogen tank includes:
identifying whether pressure and temperature of the hydrogen tank are normal; and
identifying whether a state notification function for the state of the hydrogen tank is normally operated.

16. The fuel supply method of claim 15, further comprising:
notifying a fuel cell startup disable state when it is identified that the state notification function for the hydrogen tank is not normally operated.

17. The fuel supply method of claim 15, further comprising:
controlling the startup of the fuel cell when it is identified that the state notification function for the hydrogen tank is normally operated and the pressure and temperature of the hydrogen tank are identified as normal.

18. The fuel supply method of claim 15, further comprising:
determining that the hydrogen tank is in a fuel cell startup disable state when it is identified that the state notification function for the hydrogen tank is normally operated and the pressure and temperature of the hydrogen tank are not identified as normal.

19. The fuel supply method of claim 18, wherein the controlling includes:
opening the first valve in a state, in which the second valve is closed, in the fuel cell startup disable state.

20. The fuel supply method of claim 19, further comprising:
measuring a pressure of hydrogen discharged through the fuel supply line when the first valve is opened; and
identifying the pressure and temperature states of the hydrogen tank again based on the measured pressure.
